(19) United States
(12) Patent Application Publication
(10) Pub. No.: US 2026/0025779 A1
(43) Pub. Date: Jan. 22, 2026

(54) INITATING A NETWORK DETACH UPON OCCURENCE OF A DEVICE BLOCK EVENT IN A WIRELESS COMMUNICATION NETWORK

(71) Applicant: T-Mobile USA, Inc., Bellevue, WA (US)

(72) Inventors: Anil Kumar Mariyani, Ashburn, VA (US); Naveed S. Siddiqui, Wylie, TX (US)

(21) Appl. No.: 18/776,604

(22) Filed: Jul. 18, 2024

(51) Int. Cl. H04W 60/06; H04W 12/08

(52) U.S. Cl. CPC H04W 60/06; H04W 12/08

(57) ABSTRACT

Techniques and architecture are described to trigger a network detach immediately when a mobile device is blacklisted, e.g., the mobile device is blocked or prohibited from accessing and using services provided by wireless communication networks. More particularly, the techniques and architecture provide a method that comprises determining a portable electronic device is to be blocked from accessing a wireless communication network based at least on a received notification. The method also comprises in response to the determining that the portable electronic device is to be blocked, sending a message within the wireless communication network for detaching the portable electronic device from the wireless communication network.

### BACKGROUND

Wireless communication networks provide services to many users. The users access the services of the wireless communication network via various types of electronic devices. The most common type of electronic device is a portable electronic device that is generally mobile.

A Global System for Mobile Communications Association (GSMA) device registry prevents mobile crime and fraud by sending periodic updates to United States (US) wireless communication network (also referred to as a mobile network) operators and international wireless communication network operators. Likewise, the US wireless communication network operators and international wireless communication network operators send periodic updates to the GSMA device registry. The updates include information relating to mobile devices or electronic devices (e.g., user equipment (UEs)) that access wireless communication networks for services, e.g., voice services and/or data services. Generally, the updates include information labeling the mobile devices within one of three categories. White-listed indicates that the mobile device is permitted to access services provided by wireless communication networks. Gray-listed indicates that a mobile device is on a tracking list as potentially being a problem. Gray-listed mobile devices are generally permitted to access services provided by the mobile networks. Finally, black-listed indicates that the mobile device is prohibited from accessing services provided by wireless communication networks.

Device counterfeiting and fraud may result in mobile device blocking by wireless communication network operators in the US and globally. For tackling crime or unwanted access of mobile devices, the GSMA and wireless communication network operators enforce the black-list policies and block mobile devices as soon as a mobile device status for the mobile device is received indicating that the mobile device is blocked, e.g., blacklisted. Currently, when the mobile devices are blacklisted, the mobile devices continue to use one or more network services until one of a number of conditions occurs. A first condition includes when the mobile device's current General Packet Radio Service (GPRS) Tunneling Protocol (GTP) session expires. A second condition includes when the mobile device moves out of the wireless communication network's coverage area. Finally, a third condition includes the mobile device performing a new wireless communication network attach procedure. If none of the conditions occur, then the location of the mobile device remains static, which leads to revenue leaks for the communication service provider, e.g., the wireless communication network operator, as well as unauthorized access, based upon continued use of network resources for up to a number of days. Thus, the decision to terminate or block access of a blacklisted mobile device is of utmost importance in terms of time sensitivity. Additionally, the decision to terminate or block access of a blacklisted mobile device is of utmost importance with respect to mission critical aspects, e.g., court orders, mobile device lost, stolen, etc.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIGS. 1A and 1B schematically illustrate an example arrangement of a wireless communication network and a Global System for Mobile Communications Association (GSMA) device registry, according to some implementations.

FIG. 2 is a flow diagram for an example of immediately detaching UEs from wireless communication networks, e.g., the wireless communication network of FIGS. 1A and 1B, according to some implementations.

FIG. 3 is a flow diagram for another example of immediately detaching UEs from wireless communication networks, e.g., the wireless communication network of FIGS. 1A and 1B, according to some implementations.

FIG. 4 is a flow diagram illustrating an example method for triggering a network detach immediately when a UE 114 is blacklisted, according to some implementations.

FIG. 5 schematically illustrates a component level view of a server configured for use with the techniques and architecture described herein, according to some implementations.

### DETAILED DESCRIPTION

Described herein are techniques and techniques and architecture to trigger a network detach immediately when a mobile device is blacklisted, e.g., the mobile device is blocked or prohibited from accessing and using services provided by wireless communication networks. More particularly, the techniques and architecture provide new logic on communication service providers (CSPs) wireless communication network systems to trigger a network detach immediately on blacklisted mobile devices.

As previously noted, a Global System for Mobile Communications Association (GSMA) device registry prevents mobile crime and fraud by sending periodic updates to United States (US) wireless communication network (also referred to as a mobile network) operators and international wireless communication network operators. Likewise, the US wireless communication network operators and international wireless communication network operators send periodic updates to the GSMA device registry. The updates include information relating to mobile devices or electronic devices (e.g., user equipment (UEs)) that access wireless communication networks. Generally, the updates include information labeling the mobile devices within one of three categories. White-listed indicates that the mobile device is permitted to use services provided by wireless communication networks. Gray-listed indicates that a mobile device is on a tracking list as potentially being a problem. Gray-listed mobile devices are generally permitted to use services provided by the wireless communication networks. Finally, black-listed indicates that the mobile device is prohibited from using services provided by wireless communication networks.

As an example of techniques and architecture described herein, in configurations, a first process for detaching a mobile device from a wireless communication network once it is blacklisted includes periodic GSMA server updates to a wireless communication network Equipment Identity Register (EIR) server. When the EIR server performs a unified data repository (UDR) update, with blacklisted mobile devices, the UDR sends a trigger message (SOAP/HTTP or Nudr) towards the Home Subscriber Server (HSS)/unified data management (UDM). The HSS/UDM processes the trigger message from the UDR and performs data detach procedures. The detach procedures may include, in configurations, based on the registration state of the mobile device in the UDR, one of several actions. A first action may include a HSS or mobility function sending a diameter cancel location to Mobility Management Entity (MME) in order to detach the current data session of the mobile device. Another action may include the HSS or mobility function sending a diameter registration termination request to the Internet Protocol (IP) Multimedia Subsystem (IMS) to detach the current voice session of the mobile device. A third action may include the UDM or mobility function sending a UECM deregistration notification to the Access and Mobility Management Function (AMF).

As another example of techniques and architecture described herein, in configurations, a second process of detaching a blacklisted mobile device may include a customer relationship management (CRM) of the wireless communication network operator business support system (BSS) triggering a detach of the blacklisted mobile device directly to 4G/5G UDR platforms of the wireless communication network operator. More particularly, the BSS CRM system may include a force detach on all 3GPP and 3GPP2 technologies, including, but not limited to, 2G/3G/4G/5G/6G networks. The BSS CRM system may send a provisioning trigger to the central UDR (applicable to all current and future generations of wireless communication network protocols, e.g., 2G/3G/4G/5G/6G). Current or future equivalent UDRs may notify current or future UDM about this color modification of a mobile device specified by the provisioning trigger, where the color modification indicates moving the mobile device from white-listed to black-listed, or from gray-listed to black-listed. As previously noted, white-listed indicates that the mobile device is permitted to use services provided by wireless communication networks. Gray-listed indicates that a mobile device is on a tracking list as potentially being a problem. Gray-listed mobile devices are generally permitted to use services provided by the wireless communication networks. Finally, black-listed indicates that the mobile device is prohibited from using services provided by wireless communication networks.

Current or future equivalent UDMs may process the trigger message from the UDR and perform detach procedures. As previously noted, the detach procedures may include, for example, in configurations, based on the registration state of the mobile device in the UDR, one of several actions. A first action may include a HSS or mobility function sending a diameter cancel location to a Mobility Management Entity (MME) in order to detach the current data session of the mobile device. Another action may include the HSS or mobility function sending a diameter registration termination request to an Internet Protocol (IP) Multimedia Subsystem (IMS) to detach the current voice session of the mobile device. A third action may include the UDM or mobility function sending a UECM deregistration notification to an Access and Mobility Management Function (AMF).

Accordingly, as an example, the techniques and architecture provide a method that comprises determining that a portable electronic device is to be blocked from accessing a wireless communication network based at least on a received notification. The method also comprises in response to the determining that the portable electronic device is to be blocked, sending a message within the wireless communication network for detaching the portable electronic device from the wireless communication network.

In configurations, determining the portable electronic device is to be blocked from accessing the wireless communication network comprises receiving, by an Equipment Identity Register (EIR) server of the wireless communication network from a Global System for Mobile Communications Association (GSMA) device registry, a list of portable electronic devices that are to be blocked from accessing the wireless communication network.

In configurations, the method further comprises updating, by the EIR server of the wireless communication network, a unified data repository (UDR) that portable electronic device is to be blocked from accessing the wireless communication network; and sending, by the UDR to a Home Subscriber Server (HSS)/unified data management (UDM), the message.

In configurations, determining the portable electronic device is to be blocked from accessing the wireless communication network comprises determining, by a business support system (BSS) of the wireless communication network, the portable electronic device is to be blocked from accessing the wireless communication network.

In configurations, the method further comprises updating a Global System for Mobile Communications Association (GSMA) device registry that the portable electronic device is to be blocked from all wireless communication networks.

In configurations, detaching the portable electronic device from the wireless communication network comprises sending, by a Home Subscriber Server (HSS)/unified data management (UDM) to a Mobility Management Entity (MME), a diameter cancel location message to the MME in order to detach a current data session of the portable electronic device.

In configurations, detaching the portable electronic device from the wireless communication network comprises sending, by a Home Subscriber Server (HSS)/unified data management (UDM) to an Internet Protocol (IP) Multimedia Subsystem (IMS), the message to detach a current voice session of the portable electronic device.

In configurations, detaching the portable electronic device from the wireless communication network comprises sending, by a Home Subscriber Server (HSS)/unified data management (UDM) to an Access and Mobility Management Function (AMF), a UECM deregistration notification message.

As another example, the techniques and architecture provide one or more non-transitory media comprising instructions stored thereon, the instructions being executable by one or more processors to cause the one or more processors to perform one or more actions. The actions comprise determining a portable electronic device is to be blocked from accessing a wireless communication network. The actions also comprise based upon a message within the wireless communication network, detaching the portable electronic device from the wireless communication network.

As a further example, the techniques and architecture provide a system, where the system comprises one or more processors and one or more non-transitory media comprising instructions stored thereon, the instructions being executable by the one or more processors to cause the one or more processors to perform one or more actions. The actions comprise determining a portable electronic device is to be blocked from accessing a wireless communication network. The actions also comprise based upon a message within the wireless communication network, detaching the portable electronic device from the wireless communication network.

Thus, the techniques and architecture described herein help wireless communication immediately terminate active sessions of unwanted/unauthorized mobile devices, e.g., blacklisted mobile devices. This can help address a revenue leak issue for metered usage of services provided by wireless communication networks. Additionally, the techniques and architecture facilitate stopping wireless communication network provision of voice services and data services with immediate effect for blocked mobile devices that may be requested by law enforcement, governments, insurers, retailers, operators, etc.

Certain implementations and embodiments of the disclosure will now be described more fully below with reference to the accompanying figures, in which various aspects are shown. However, the various aspects may be implemented in many different forms and should not be construed as limited to the implementations set forth herein. The disclosure encompasses variations of the embodiments, as described herein. Like numbers refer to like elements throughout.

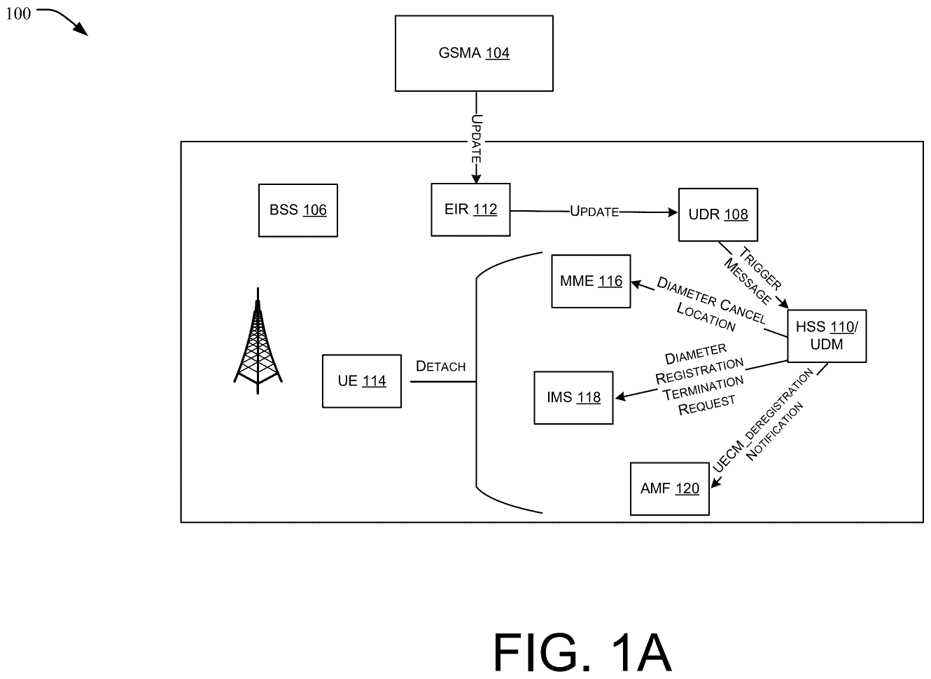

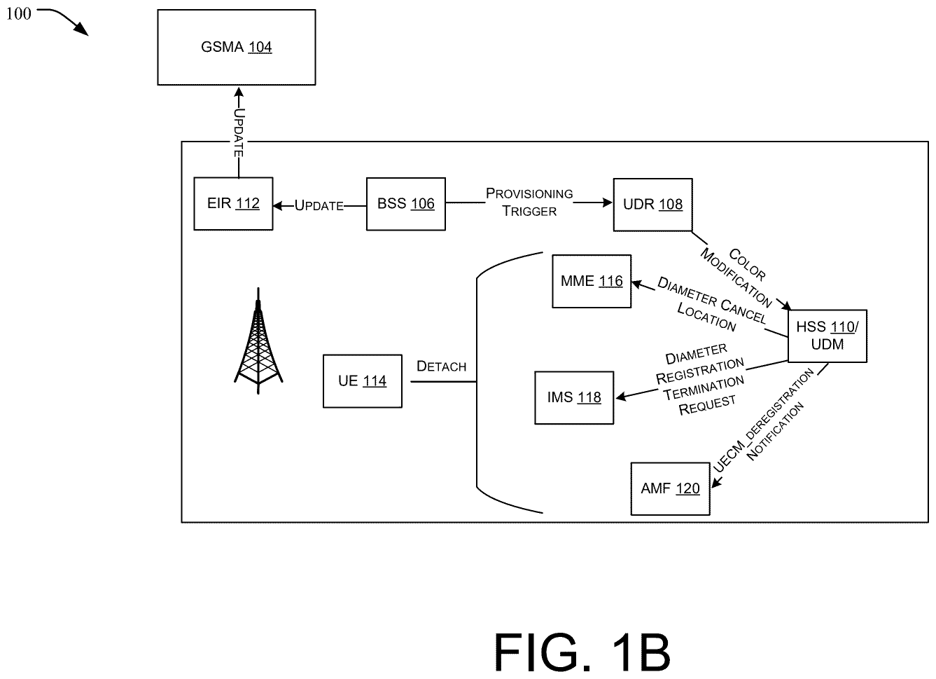

FIGS. 1A and 1B schematically illustrate an example arrangement 100 of a wireless communication network 102 and a Global System for Mobile Communications Association (GSMA) device registry 104. The wireless communication network 102 may include a business support system (BSS) 106 and a unified data repository (UDR) 108. The first wireless communication network 102a may also include a Home Subscriber Server (HSS)/unified data management (UDM) 110 and an Equipment Identity Register (EIR) server 112. A single user equipment (UE) (mobile device, electronic device, etc.) 114 is illustrated in the wireless communication network 102 in the example of FIGS. 1A and 1B. As is known, generally, the wireless communication network 102 may include multiple UEs 114 attached to the wireless communication network 102 to obtain voice and/or data services from the wireless communication network 102. Likewise, as is known, the wireless communication network 102 generally includes additional components that are not illustrated in the example arrangement of FIGS. 1A and 1B and are not described herein.

The GSMA device registry 104 prevents mobile crime and fraud by sending periodic updates to United States (US) wireless communication network operators and international wireless communication network operators. Likewise, the US wireless communication network operators and international wireless communication network operators send periodic updates to the GSMA device registry 104. The updates include information relating to UE 114 that access wireless communication networks, e.g., wireless communication network 102. Generally, the updates include information labeling the UE 114 within one of three categories. White-listed indicates that the UE 114 is permitted to access and use services provided by the wireless communication network 102. Gray-listed indicates that the UE 114 is on a tracking list as potentially being a problem. Gray-listed UEs are generally permitted to access and use services provided by the wireless communication network 102. Finally, black-listed indicates that the UE 114 is prohibited from accessing and using services provided by the wireless communication network 102.

Referring to FIG. 1A, as an example of techniques and architecture described herein, in configurations, a first process for detaching the UE 114 from the wireless communication network 102 once the UE 114 is blacklisted includes periodic GSMA registry 104 updates to the EIR server 112. When the EIR server 112 performs UDR 108 update, with blacklisted UEs, the UDR 108 sends a trigger message (SOAP/HTTP or Nudr) towards the HSS 110/unified data management (UDM). The HSS 110/UDM processes the trigger message from the UDR 108 and performs data detach procedures. The detach procedures may include, in configurations, based on the registration state of the UE 114 in the UDR 108, one of several actions. A first action may include the HSS 110/UDM or mobility function sending a diameter cancel location to a Mobility Management Entity (MME) 116 in order to detach the current data session of the UE 114. Another action may include the HSS 110/UDM or mobility function sending a diameter registration termination request to an Internet Protocol (IP) Multimedia Subsystem (IMS) to detach the current voice session of the UE 114. A third action may include the HSS 110/UDM or mobility function sending a UECM deregistration notification to an Access and Mobility Management Function (AMF) 120.

Referring to FIG. 1B, as another example of techniques and architecture described herein, in configurations, a second process of detaching a blacklisted UE 114 may be described. In configurations, this second process may occur when an operator of the wireless communication network 102 determines that the UE 114 should be blacklisted. The second process may include a customer relationship management (CRM) of the wireless communication network operator BSS 106 triggering a detach of the blacklisted UE 114 directly to 4G/5G UDR 108 platforms of the wireless communication network operator. More particularly, the BSS 106 CRM system may include a force detach on all 3GPP and 3GPP2 technologies, including, but not limited to, 2G/3G/4G/5G/6G networks. The BSS 106 CRM system may send a provisioning trigger to the central UDR 108 (applicable to all current and future generations of wireless communication network protocols, e.g., 2G/3G/4G/5G/6G). The UDR 108 may notify the HSS 110/UDM about this color modification specified by the provisioning trigger, where the color modification indicates moving the mobile device from white-listed to black-listed, or from gray-listed to black-listed. As previously noted, white-listed indicates that the mobile device is permitted to use services provided by wireless communication networks. Gray-listed indicates that a mobile device is on a tracking list as potentially being a problem. Gray-listed mobile devices are generally permitted to use services provided by the wireless communication networks. Finally, black-listed indicates that the mobile device is prohibited from using services provided by wireless communication networks.

The HSS 110/UDM may process the trigger message from the UDR 108 and perform detach procedures. As previously noted, the detach procedures may include, for example, in configurations, based on the registration state of the UE 114 in the UDR 108, one of several actions. A first action may include a HSS or mobility function sending a diameter cancel location to the MME 116 in order to detach the current data session of the mobile device. Another action may include the HSS 110/UDM or mobility function sending a diameter registration termination request to the IMS 118 to detach the current voice session of the UE 114. A third action may include the HSS 110/UDM or mobility function sending a UECM deregistration notification to the AMF 120. In configurations, the BSS 106 may update the EIR 112 that the UE 114 is blacklisted. The EIR 112 may then update the GSMA 104 that the UE 114 is blacklisted.

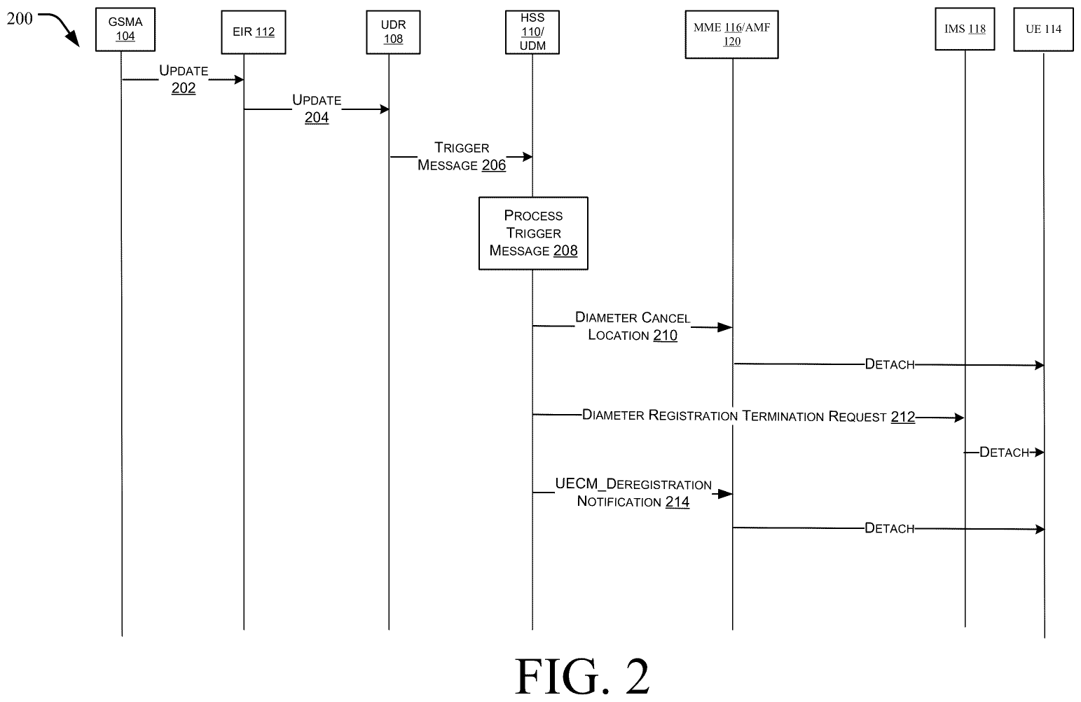

FIG. 2 is a flow diagram 200 for an example of immediately detaching UEs, e.g., UEs 114, from wireless communication networks, e.g., wireless communication network 102, when the UEs are blacklisted. At 202, the GSMA registry 104 provides periodic updates to the EIR server 112. At 204 the EIR server 112 performs UDR 108 update with blacklisted UEs. At 206, the UDR 108 sends a trigger message (SOAP/HTTP or Nudr) towards the HSS 110/unified data management (UDM). At 208, the HSS110/UDM processes the trigger message from the UDR 108 and performs data detach procedures. The detach procedures may include, in configurations, based on the registration state of the UE 114 in the UDR 108, one of several actions. A first action may include, at 210, the HSS 110/UDM or mobility function sending a diameter cancel location to the MME 116 in order to detach the current data session of the UE 114. Another action may include, 212, the HSS 110/UDM or mobility function sending a diameter registration termination request to the IMS to detach the current voice session of the UE 114. A third action may include, at 214, the HSS 110/UDM or mobility function sending a UECM deregistration notification to the AMF 120.

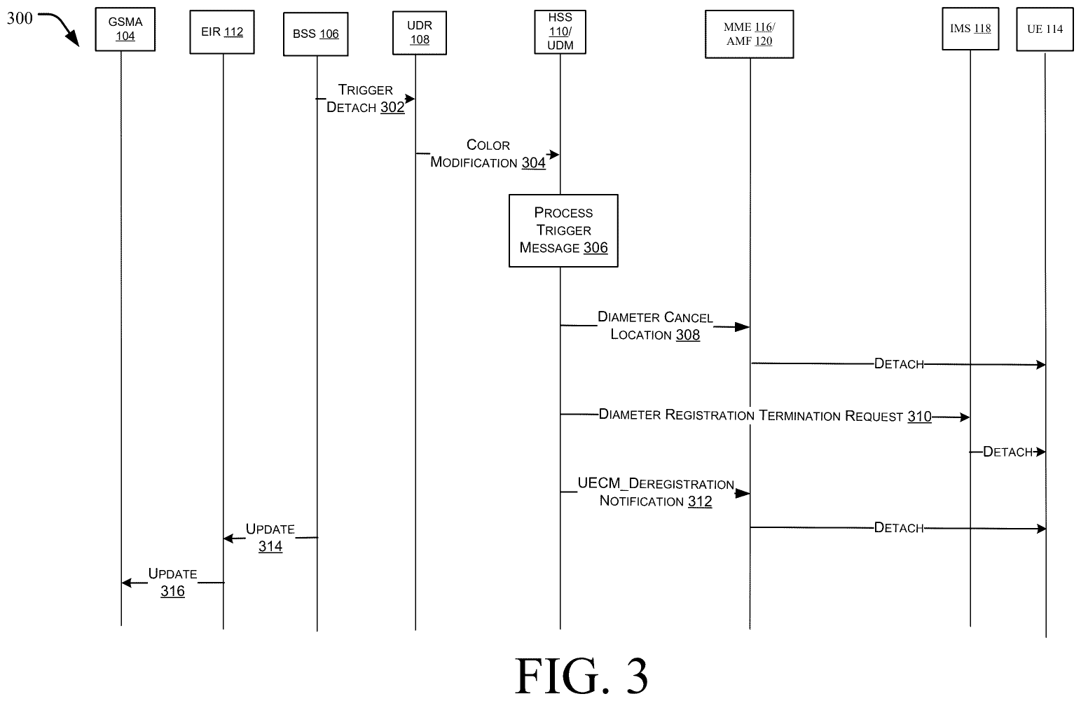

FIG. 3 is a flow diagram 300 for another example of immediately detaching UEs, e.g., UEs 114, from wireless communication networks, e.g., wireless communication network 102, when the UEs are blacklisted. In configurations, this second process may occur when an operator of the wireless communication network 102 determines that the UE 114 should be blacklisted. A customer relationship management (CRM) of the wireless communication network operator BSS 106 triggers or applies a detach of the blacklisted UE 114 directly to 4G/5G UDR 108 platforms of the wireless communication network operator. More particularly, the BSS 106 CRM system may include a force detach on all 3GPP and 3GPP2 technologies, including, but not limited to, 2G/3G/4G/5G/6G networks. Thus, at 302, the BSS 106 CRM system may send a provisioning trigger to the central UDR 108 (applicable to all current and future generations of wireless communication network protocols, e.g., 2G/3G/4G/5G/6G). At 304, the UDR 108 may notify the HSS 110/UDM about this color modification specified by the provisioning trigger, where the color modification indicates moving the mobile device from white-listed to black-listed, or from gray-listed to black-listed. As previously noted, white-listed indicates that the mobile device is permitted to use services provided by wireless communication networks. Gray-listed indicates that a mobile device is on a tracking list as potentially being a problem. Gray-listed mobile devices are generally permitted to use services provided by the wireless communication networks. Finally, black-listed indicates that the mobile device is prohibited from using services provided by wireless communication networks.

At 306, the HSS 110/UDM may process the trigger message from the UDR 108 and perform detach procedures. As previously noted, the detach procedures may include, for example, in configurations, based on the registration state of the UE 114 in the UDR 108, one of several actions. A first action may include, at 308, a HSS or mobility function sending a diameter cancel location to the MME 116 in order to detach the current data session of the mobile device. Another action may include, at 310, the HSS 110/UDM or mobility function sending a diameter registration termination request to the IMS 118 to detach the current voice session of the UE 114. A third action may include, at 312, the HSS 110/UDM or mobility function sending a UECM deregistration notification to the AMF 120. In configurations, at 314, the BSS 106 may update the EIR 112 that the UE 114 is blacklisted. At 316, the EIR 112 may then update the GSMA 104 that the UE 114 is blacklisted.

In configurations, if the operator of the wireless communication network 102, e.g., the BSS 106 CRM, has determined that the UE 114 should be blacklisted, then flow diagram 300 may include UDR 108 updating a “blacklist” at the EIR server 112. The EIR server 112 may then update the GSMA registry 104 with the blacklisted UE 114.

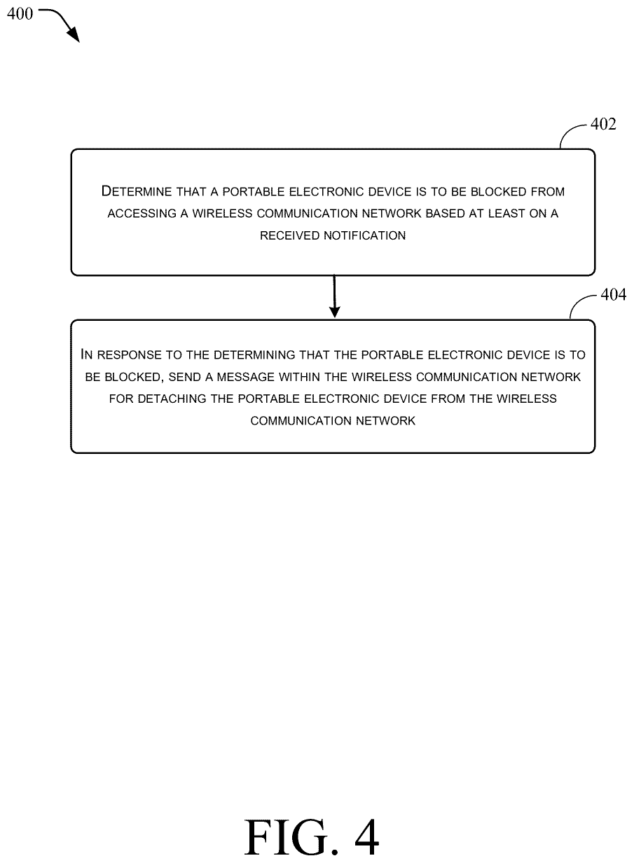

FIG. 4 is a flow diagram illustrating example processes associated with the automated testing arrangement discussed herein. The process is illustrated as a collection of blocks in a logical flow diagram, which represent a sequence of operations, some or all of which can be implemented in hardware, software, or a combination thereof. In the context of software, the blocks represent computer-executable instructions stored on one or more computer-readable media that, when executed by one or more processor(s), performs the recited operations. Generally, computer-executable instructions include routines, programs, objects, components, encryption, deciphering, compressing, recording, data structures and the like that perform particular functions or implement particular abstract data types.

The order in which the operations are described should not be construed as a limitation. Any number of the described blocks can be combined in any order and/or in parallel to implement the processes, or alternative processes, and not all of the blocks need be executed. For discussion purposes, the processes herein are described with reference to the frameworks, architectures and environments described in the examples herein, although the processes may be implemented in a wide variety of other frameworks, architectures or environments.

FIG. 4 is a flow diagram illustrating an example method 400 for triggering a network detach immediately when a mobile device, e.g., UE 114, is blacklisted, e.g., the mobile device is blocked or prohibited from accessing and using services provided by wireless communication networks, according to some implementations.

At 402, it is determined that a portable electronic device is to be blocked from accessing a wireless communication network based at least on a received notification. For example, a first process for detaching the UE 114 from the wireless communication network 102 once the UE 114 is blacklisted includes periodic GSMA registry 104 updates to the EIR server 112. A second process of detaching a blacklisted UE 114 may include a customer relationship management (CRM) of the wireless communication network operator BSS 106 triggering a detach of the blacklisted UE 114 directly to 4G/5G UDR 108 platforms of the wireless communication network operator.

At 404, in response to the determining that the portable electronic device is to be blocked, a message is sent within the wireless communication network for detaching the portable electronic device from the wireless communication network. For example, referring to FIG. 1A, as previously noted, a first process for detaching the UE 114 from the wireless communication network 102 once the UE 114 is blacklisted includes periodic GSMA registry 104 updates to the EIR server 112. When the EIR server 112 performs UDR 108 update, with blacklisted UEs, the UDR 108 sends a trigger message (SOAP/HTTP or Nudr) towards the HSS 110/unified data management (UDM). The HSS 110/UDM processes the trigger message from the UDR 108 and performs data detach procedures. The detach procedures may include, in configurations, based on the registration state of the UE 114 in the UDR 108, one of several actions. A first action may include the HSS 110/UDM or mobility function sending a diameter cancel location to a Mobility Management Entity (MME) 116 in order to detach the current data session of the UE 114. Another action may include the HSS 110/UDM or mobility function sending a diameter registration termination request to an Internet Protocol (IP) Multimedia Subsystem (IMS) to detach the current voice session of the UE 114. A third action May include the HSS 110/UDM or mobility function sending a UECM deregistration notification to an Access and Mobility Management Function (AMF) 120.

Referring to FIG. 1B, as another example of techniques and architecture described herein, in configurations, a second process of detaching a blacklisted UE 114 may include a customer relationship management (CRM) of the wireless communication network operator BSS 106 triggering a detach of the blacklisted UE 114 directly to 4G/5G UDR 108 platforms of the wireless communication network operator. More particularly, the BSS 106 CRM system may include a force detach on all 3GPP and 3GPP2 technologies, including, but not limited to, 2G/3G/4G/5G/6G networks. The BSS 106 CRM system may send a provisioning trigger to the central UDR 108 (applicable to all current and future generations of wireless communication network protocols, e.g., 2G/3G/4G/5G/6G). Current or future equivalent UDRs 108 may notify current or future HSS 110/UDM about this color modification specified by the provisioning trigger, where the color modification indicates moving the mobile device from white-listed to black-listed, or from gray-listed to black-listed. As previously noted, white-listed indicates that the mobile device is permitted to use services provided by wireless communication networks. Gray-listed indicates that a mobile device is on a tracking list as potentially being a problem. Gray-listed mobile devices are generally permitted to use services provided by the wireless communication networks. Finally, black-listed indicates that the mobile device is prohibited from using services provided by wireless communication networks.

Current or future equivalent HSS 110/UDMs may process the trigger message from the UDR 108 and perform detach procedures. As previously noted, the detach procedures may include, for example, in configurations, based on the registration state of the UE 114 in the UDR 108, one of several actions. A first action may include a HSS or mobility function sending a diameter cancel location to the MME 116 in order to detach the current data session of the mobile device. Another action may include the HSS 110/UDM or mobility function sending a diameter registration termination request to the IMS 118 to detach the current voice session of the UE 114. A third action may include the HSS 110/UDM or mobility function sending a UECM deregistration notification to the AMF 120.

UE 114 may be implemented as any suitable mobile computing device configured to communicate over a wireless and/or wireline network, including, without limitation, a mobile phone (e.g., a smart phone), a tablet computer, a laptop computer, a portable digital assistant (PDA), a wearable computer (e.g., electronic/smart glasses, a smart watch, fitness trackers, etc.), a networked digital camera, and/or similar mobile devices. Although this description predominantly describes the UE 114 as being “mobile” (i.e., configured to be carried and moved around), it is to be appreciated that the UE 114 may represent various types of communication devices that are generally stationary as well, such as televisions, desktop computers, game consoles, set top boxes, Internet of Things (IoT) devices, and the like. In this sense, the terms “communication device,” “wireless device,” “wireline device,” “mobile device,” “computing device,” “portable electronic device,” and “user equipment (UE)” may be used interchangeably herein to describe any communication device capable of performing the techniques described herein. Furthermore, the UE 114 may be capable of communicating over wired networks, and/or wirelessly using any suitable wireless communications/data technology, protocol, or standard, such as Global System for Mobile Communications (GSM), Time Division Multiple Access (TDMA), Universal Mobile Telecommunications System (UMTS), Evolution-Data Optimized (EVDO), Long Term Evolution (LTE), Advanced LTE (LTE+), Generic Access Network (GAN), Unlicensed Mobile Access (UMA), Code Division Multiple Access (CDMA), Orthogonal Frequency Division Multiple Access (OFDM), General Packet Radio Service (GPRS), Enhanced Data GSM Environment (EDGE), Advanced Mobile Phone System (AMPS), High Speed Packet Access (HSPA), evolved HSPA (HSPA+), Voice over IP (VOIP), Voice over LTE (VOLTE), 5G, IEEE 802.1x protocols, WiMAX, Wi-Fi, and/or any future IP-based network technology or evolution of an existing IP-based network technology.

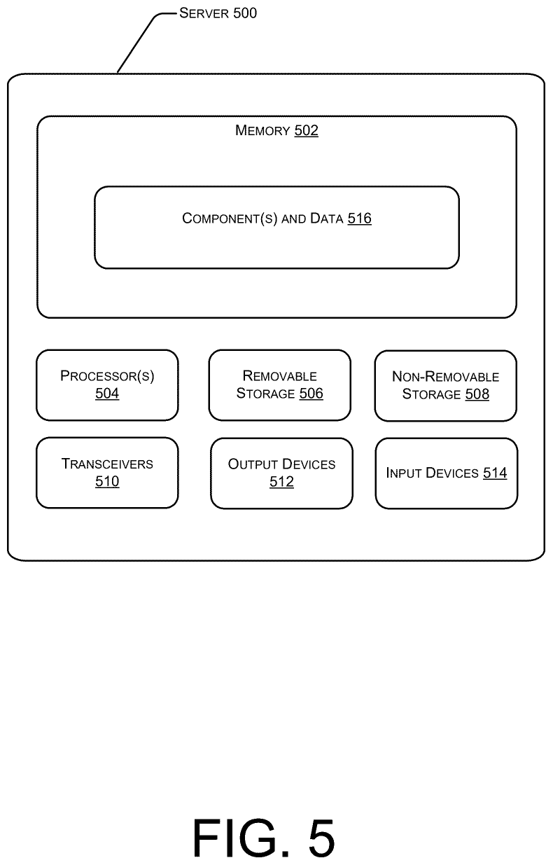

FIG. 5 illustrates a component level view of a server 500 configured for use within a wireless communication network, e.g., wireless communication network 102, in order to provide various services within the wireless communication network, according to the techniques described herein. For example, the server 500 may serve as a BSS 106, e.g., one or more servers 500 may be configured to serve as a BSS 106. As another example, the server 500 may serve as an EIR server 112, e.g., one or more servers 500 may be configured to serve as an EIR server 112. As another example, the server 500 may serve as a HSS 110, e.g., one or more servers 500 may be configured to serve as a HSS 110. As another example, the server 500 may serve as a UDR 108, e.g., one or more servers 500 may be configured to serve as a UDR 108.

As illustrated, the server 500 comprises a system memory 502 that may store one or more components and/or applications and data 516 for interacting with mobile devices, e.g., UE 114, as described herein. Also, the server 500 may include processor(s) 504, a removable storage 506, a non-removable storage 508, transceivers 510, output device(s) 512, and input device(s) 514.

In various implementations, system memory 502 is volatile (such as RAM), non-volatile (such as ROM, flash memory, etc.), or some combination of the two. In some implementations, the processor(s) 504 is a Central Processing Unit (CPU), a Graphics Processing Unit (GPU), or both CPU and GPU, or any other sort of processing unit.

The server 500 may also include additional data storage devices (removable and/or non-removable) such as, for example, magnetic disks, optical disks, or tape. Such additional storage is illustrated in FIG. 5 by removable storage 506 and non-removable storage 508. The one or more of the memory 502, the removable storage 506 and/or the non-removable storage 508 may include module(s) and data 516 (illustrated in the memory 502). The module(s) and data 516 may include instructions executable by, for example, the processor(s) 504.

Non-transitory computer-readable media may include volatile and nonvolatile, removable and non-removable tangible, physical media implemented in technology for storage of information, such as computer readable instructions, data structures, program modules, or other data. System memory 502, removable storage 506 and non-removable storage 508 are all examples of non-transitory computer-readable media. Non-transitory computer-readable media include, but are not limited to, RAM, ROM, EEPROM, flash memory or other memory technology, CD-ROM, Digital Versatile Disks (DVD) or other optical storage, magnetic cassettes, magnetic tape, magnetic disk storage or other magnetic storage devices, or any other tangible, physical medium which can be used to store the desired information and which can be accessed by the server 500. Any such non-transitory computer-readable media may be part of the server 500.

In some implementations, the transceivers 510 include any sort of transceivers known in the art. For example, the transceivers 510 may include wired communication components, such as an Ethernet port, for communicating with other networked devices. Also, or instead, the transceivers 510 may include wireless modem(s) to facilitate wireless connectivity with other computing devices. Further, the transceivers 510 may include a radio transceiver that performs the function of transmitting and receiving radio frequency communications via an antenna.

In some implementations, the output devices 512 include any sort of output devices known in the art, such as a display (e.g., a liquid crystal display), speakers, a vibrating mechanism, or a tactile feedback mechanism. Output devices 512 also include ports for one or more peripheral devices, such as headphones, peripheral speakers, or a peripheral display.

In various implementations, input devices 514 include any sort of input devices known in the art. For example, input devices 514 may include a camera, a microphone, a keyboard/keypad, a computer mouse, or a touch-sensitive display. A keyboard/keypad may be a push button numeric dialing pad (such as on a typical telecommunication device), a multi-key keyboard (such as a conventional QWERTY keyboard), or one or more other types of keys or buttons, and may also include a joystick-like controller and/or designated navigation buttons, or the like.

Some or all operations of the processes described above can be performed by execution of computer-readable instructions stored on a computer storage medium, as defined below. The term “computer-readable instructions” as used in the description and claims, include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

The computer storage media may include volatile memory (such as random access memory (RAM)) and/or non-volatile memory (such as read-only memory (ROM), flash memory, etc.). The computer storage media may also include additional removable storage and/or non-removable storage including, but not limited to, flash memory, magnetic storage, optical storage, and/or tape storage that may provide non-volatile storage of computer-readable instructions, data structures, program modules, and the like.

A non-transient computer storage medium is an example of computer-readable media. Computer-readable media includes at least two types of computer-readable media, namely computer storage media and communications media. Computer storage media includes volatile and non-volatile, removable and non-removable media implemented in any process or technology for storage of information such as computer-readable instructions, data structures, program modules, or other data. Computer storage media includes, but is not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer-readable instructions, data structures, program modules, or other data in a modulated data signal, such as a carrier wave, or other transmission mechanism. As defined herein, computer storage media do not include communication media.

The computer-readable instructions stored on one or more non-transitory computer storage media that, when executed by one or more processors, may perform operations described above with reference to FIGS. 1A, 1B, 2, 3, and 4. Generally, computer-readable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the processes.

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A method comprising:
determining that a portable electronic device is to be blocked from accessing a wireless communication network based at least on a received notification; and
in response to the determining that the portable electronic device is to be blocked, sending a message within the wireless communication network for detaching the portable electronic device from the wireless communication network.

2. The method of claim 1, wherein notification is triggered by receiving, by an Equipment Identity Register (EIR) server of the wireless communication network from a Global System for Mobile Communications Association (GSMA) device registry, a list of portable electronic devices that are to be blocked from accessing the wireless communication network.

3. The method of claim 2, wherein the determining that the portable electronic device is to be blocked from accessing the wireless communication network comprises determining by a Home Subscriber Server (HSS) or a unified data management (UDM) of the wireless communication network that the portable electronic device is to be blocked from accessing the wireless communication network, further comprising:
updating, by the EIR server of the wireless communication network, a unified data repository (UDR) that the portable electronic device is to be blocked from accessing the wireless communication network; and
sending, by the UDR to the HSS or the UDM, the notification.

4. The method of claim 1, wherein the determining that the portable electronic device is to be blocked from accessing the wireless communication network comprises determining, by a business support system (BSS) of the wireless communication network, the portable electronic device is to be blocked from accessing the wireless communication network.

5. The method of claim 4, further comprising updating a Global System for Mobile Communications Association (GSMA) device registry that the portable electronic device is to be blocked from all wireless communication networks.

6. The method of claim 1, wherein detaching the portable electronic device from the wireless communication network comprises sending, by a Home Subscriber Server (HSS) or unified data management (UDM) to a Mobility Management Entity (MME), a diameter cancel location message to the MME in order to detach a current data session of the portable electronic device.

7. The method of claim 1, wherein the sending the message for detaching the portable electronic device from the wireless communication network comprises sending, by a Home Subscriber Server (HSS) or unified data management (UDM) to an Internet Protocol (IP) Multimedia Subsystem (IMS), the message to detach a current voice session of the portable electronic device.

8. The method of claim 1, wherein the sending the message for detaching the portable electronic device from the wireless communication network comprises sending, by a Home Subscriber Server (HSS) or unified data management (UDM) to an Access and Mobility Management Function (AMF), a UECM deregistration notification message.

9. A system comprising:
one or more processors; and
one or more non-transitory media comprising instructions stored thereon, the instructions being executable by the one or more processors to cause the one or more processors to perform one or more actions comprising:
determining that a portable electronic device is to be blocked from accessing a wireless communication network based at least on a received notification; and
in response to the determining that the portable electronic device is to be blocked, sending a message within the wireless communication network for detaching the portable electronic device from the wireless communication network.

10. The system of claim 9, wherein notification is triggered by receiving, by an Equipment Identity Register (EIR) server of the wireless communication network from a Global System for Mobile Communications Association (GSMA) device registry, a list of portable electronic devices that are to be blocked from accessing the wireless communication network.

11. The system of claim 10, wherein the determining that the portable electronic device is to be blocked from accessing the wireless communication network comprises determining by a Home Subscriber Server (HSS) or a unified data management (UDM) of the wireless communication network that the portable electronic device is to be blocked from accessing the wireless communication network and the actions further comprise:
updating, by the EIR server of the wireless communication network, a unified data repository (UDR) that the portable electronic device is to be blocked from accessing the wireless communication network; and
sending, by the UDR to the HSS or the UDM, the message.

12. The system of claim 9, wherein the determining that the portable electronic device is to be blocked from accessing the wireless communication network comprises determining, by a business support system (BSS) of the wireless communication network, the portable electronic device is to be blocked from accessing the wireless communication network.

13. The system of claim 12, wherein the actions further comprise updating a Global System for Mobile Communications Association (GSMA) device registry that the portable electronic device is to be blocked from all wireless communication networks.

14. The system of claim 9, wherein detaching the portable electronic device from the wireless communication network comprises sending, by a Home Subscriber Server (HSS) or unified data management (UDM) to a Mobility Management Entity (MME), a diameter cancel location message to the MME in order to detach a current data session of the portable electronic device.

15. The system of claim 9, wherein detaching the portable electronic device from the wireless communication network comprises sending, by a Home Subscriber Server (HSS) or unified data management (UDM) to an Internet Protocol (IP) Multimedia Subsystem (IMS), the message to detach a current voice session of the portable electronic device.

16. The system of claim 9, wherein the sending the message for detaching the portable electronic device from the wireless communication network comprises sending, by a Home Subscriber Server (HSS) or unified data management (UDM) to an Access and Mobility Management Function (AMF), a UECM deregistration notification message.

17. One or more non-transitory computer-readable media storing computer-executable instructions that, when executed by one or more processors, cause the one or more processors to perform actions comprising:
determining a portable electronic device is to be blocked from accessing a wireless communication network based at least on a received notification; and
in response to the determining that the portable electronic device is to be blocked, sending a message within the wireless communication network for detaching the portable electronic device from the wireless communication network.

18. The one or more non-transitory computer-readable media of claim 17, wherein notification is triggered by receiving, by an Equipment Identity Register (EIR) server of the wireless communication network from a Global System for Mobile Communications Association (GSMA) device registry, a list of portable electronic devices that are to be blocked from accessing the wireless communication network.

19. The one or more non-transitory computer-readable media of claim 17, wherein the determining that the portable electronic device is to be blocked from accessing the wireless communication network comprises determining, by a business support system (BSS) of the wireless communication network, the portable electronic device is to be blocked from accessing the wireless communication network.

20. The one or more non-transitory computer-readable media of claim 19, wherein the actions further comprise:
updating a Global System for Mobile Communications Association (GSMA) device registry that the portable electronic device is to be blocked from all wireless communication networks.
